(19) United States
(12) Patent Application Publication
(10) Pub. No.: US 2009/0290362 A1
(43) Pub. Date: Nov. 26, 2009

(54) LIGHT EMITTING DIODE DEVICE

(75) Inventors: Pai-Sheng Wei, Tu-Cheng (TW); Chia-Shou Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Foxconn Technology Co., Ltd., Tu-Cheng (TW)

(21) Appl. No.: 12/202,399

(22) Filed: Sep. 1, 2008

(30) Foreign Application Priority Data
May 23, 2008 (CN) 200810067417.4

(51) Int. Cl. F21V 29/00

(52) U.S. Cl. 362/373

(57) ABSTRACT

An exemplary light emitting diode (LED) device includes a base, a plurality of LED chips, a plurality of encapsulation materials and a heat dissipation substrate. The LED chips are mounted on a top surface of the base. The encapsulation materials are provided on the top surface of the base and encapsulate the LED chips therein. The heat dissipation substrate is fixedly attached to a bottom surface of the base. The heat dissipation substrate is of a porous material and defines a plurality of pores therein. The pores communicate with each other.

### BACKGROUND

1. Technical Field

The present invention relates to light emitting diodes, and more specifically to a light emitting diode device.

2. Description of Related Art

Presently, LEDs (light emitting diode) are preferred for use in non-emissive display devices rather than CCFLs (cold cathode fluorescent lamp) due to their high brightness, long lifespan, and wide color range.

Referring to FIG. 3, a LED device 20 includes a substrate 22, a plurality of LED chips 21 disposed on the substrate 22 and an encapsulation material 24 encapsulating the LED chips 21 on the substrate 22. Each of the LED chips 21 is electrically connected to the substrate 22 via a gold wire 25. The substrate 22 is a flat plate of thermally conductive material. Heat generated by the LED chips 21 is dissipated into a surrounding environment of the LED device 20 via the substrate 22.

However, the LED chip 21 is preferred to be more powerful while maintaining a smaller size. Hot spots form between each of the LED chips 21 and the substrate 22, and heat generated thereat needs to be transferred to other areas of the substrate 22 and further dissipated to the surrounding environment. The substrate 22 has low heat transfer efficiency due to its flat shape restriction and simplex material restriction. Therefore, the heat in the hot spots can not be efficiently dissipated and the hot spots remain.

It is thus desired to provide a LED device which can overcome the described limitations.

### SUMMARY

A light emitting diode device is provided. According to an exemplary embodiment, the light emitting diode device includes a base, a plurality of light emitting diode chips, a plurality of encapsulation materials and a heat dissipation substrate. The light emitting diode chips are mounted on a top surface of the base. The encapsulation materials are provided on the top surface of the base and encapsulate the light emitting diode chips therein. The heat dissipation substrate is fixedly attached to a bottom surface of the base. The heat dissipation substrate is of a porous material and defines a plurality of pores therein. The pores communicate with each other.

Other advantages and novel features of the present invention will become more apparent from the following detailed description of embodiment when taken in conjunction with the accompanying drawings.

### BRIEF DESCRIPTION OF THE DRAWINGS

FIG. 1 is a schematic view of a light emitting diode device in accordance with a first exemplary embodiment of the present invention.

FIG. 2 is a schematic view of a light emitting diode device in accordance with a second exemplary embodiment of the present invention.

FIG. 3 is a schematic view of a light emitting diode device according to related art.

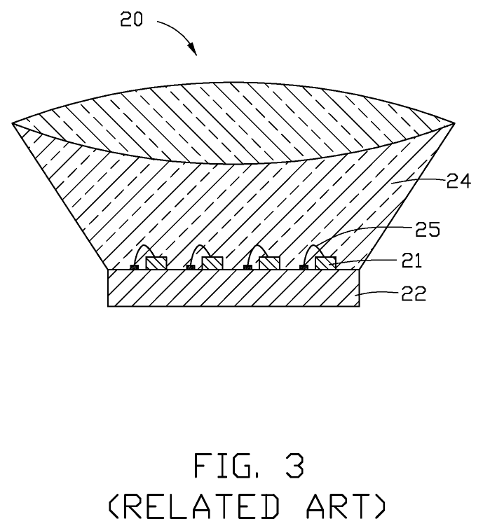

### DETAILED DESCRIPTION OF THE EMBODIMENTS

Reference will now be made to the drawings to describe the various present embodiments in detail.

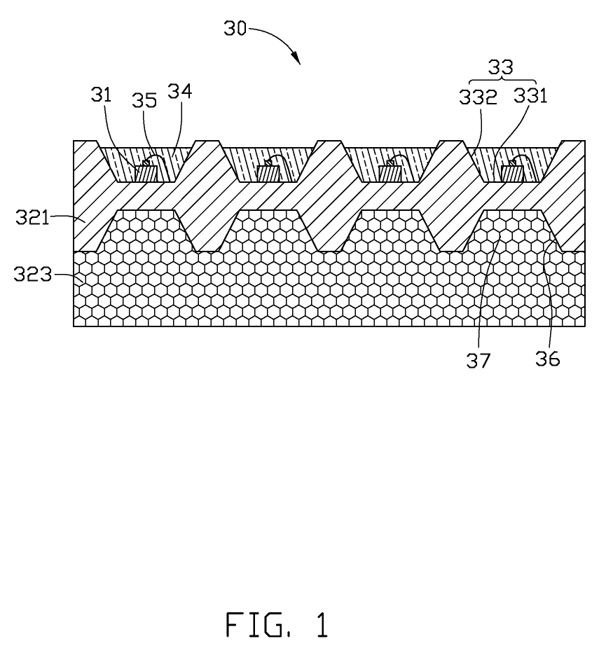

Referring to FIG. 1, a light emitting diode (LED) device 30 includes a base 321, a plurality of LED chips 31 disposed thereon, a plurality of encapsulation materials 34 disposed on the base 321 and protecting the LED chips 31, and a heat dissipation substrate 323 located under the base 321.

The base 321 provides high thermal conductivity. In this embodiment, the base 321 is a metal such as aluminum, copper or other metal. The base 321 defines a plurality of receiving recesses 33 therein. The receiving recesses 33 are concave below a top surface of the base 321 towards a bottom surface of the base 321, being bowl-shaped, and including a bottom face 331 parallel to the top surface of the base 321 and an annular side face 332 extending upwardly and outwardly from the bottom face 331 to the top surface of the base 321. The LED chips 31 are received in the receiving recesses 33 of the base 321, respectively. Each of the LED chips 31 is electrically connected to the base 321 via a gold wire 35. The base 321 defines a plurality of engaging recesses 36 on the bottom surface thereof. The engaging recesses 36 are concaved inwardly from the bottom surface of the base 321 towards the top surface of the base 321. Each of the engaging recesses 36 is bowl-shaped, and has a same shape as the receiving recess 33. Each engaging recess 36 aligns with a corresponding receiving recess 33 and is located directly thereunder. The receiving recesses 33 align with the engaging recesses 36 along a vertical axis of the base 321, respectively.

A top surface of the heat dissipation substrate 323 is fixed to the bottom surface of the base 321. A plurality of protrusions 37 protrude upwardly from the top surface of the heat dissipation substrate 323. The protrusions 37 correspond to the engaging recesses 36 of the bottom surface of the base 321, respectively. Each of the protrusions 37 has a shape and a size substantially equal to those of each of the engaging recesses 36. The protrusions 37 of the heat dissipation substrate 323 are received in the engaging recesses 36 of the base 321, respectively. The heat dissipation substrate 323 is of a porous material having a high thermal conductivity, and defines a plurality of pores therein, wherein the pores communicate with each other. In this embodiment, the heat dissipation substrate 323 is of a metallic foam material, and the heat dissipation substrate 323 and the base 321 are thermally connected together through each protrusion 37 engaging in a corresponding engaging recess 36. A thickness of a flat portion of the heat dissipation substrate 323 on which the protrusion 37 are provided is about 2 mm (millimeter).

The encapsulation material 34 utilizes light-permeable material, such as glass, epoxy, resin, or other. The encapsulation material 34 is filled in a receiving recess 36 for encapsulating the corresponding LED chip 31 therein.

During operation, the LED chips 31 generate heat. Since the LED chips 31 are thermally connected with the base 321, the heat generated by the LED chips 31 is firstly gathered in contact areas between the LED chips 31 and the base 321 and then further conducted to other areas of the base 321 along a horizontal axis thereof and conducted to the heat dissipation substrate 323 along the vertical axis of the base 321, simultaneously. Since the engaging recesses 36 are located under the LED chips 31 and the protrusions 37 are filled in the engaging recesses 36, the heat is quickly conducted to the heat dissipation substrate 323 through the protrusions 37 due to the large contact area between the base 321 and the heat dissipation substrate 323, which improves the heat conduction of the base 321 along the vertical axis thereof and further improves the heat conducting efficiency between the base 321 and the heat dissipation substrate 323. For the large quantities of pores defined in the heat dissipation substrate 323, a total heat dissipation area of the heat dissipation substrate 323 is greatly increased and the heat can be further quickly dissipated to a surrounding environment by the heat dissipation substrate 323, thereby enhancing heat dissipation effectiveness of the LED device 30.

Alternatively, a heat sink may additionally be attached to the bottom surface of the heat dissipation substrate 323, further increasing the heat dissipation effectiveness of the LED device 30. The heat dissipation substrate 323 can be other porous material, such as sintered metal powder, with a high thermal conductivity. If the base 321 is aluminum, the heat dissipation substrate 323 can be a porous anodic oxidation film formed on the bottom surface of the metal base 321.

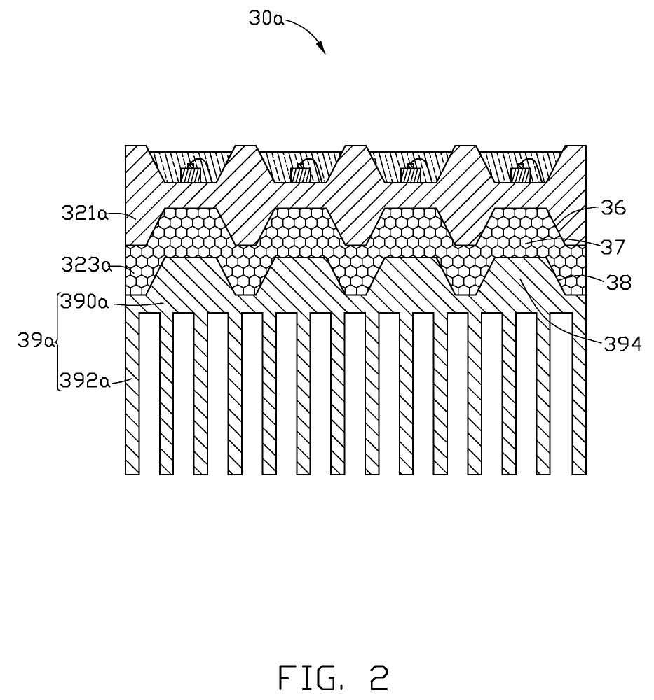

FIG. 2 shows a second embodiment of the LED device 30a, differing from the previous embodiment only in that the base 321a is aluminum, the heat dissipation substrate 323a is a porous anodic alumina film formed under the base 321a, and the LED device 30a further includes a heat sink 39a thermally attached to the heat dissipation substrate 323a. The anodic alumina film has a configuration substantially matching the bottom surface of the base 321a, and defines a plurality of pores communicating with each other. The base 321a is provided with a plurality of engaging recesses 36 at a bottom surface thereof. The anodic alumina film is provided with a plurality of protrusions 37 at a top thereof, engaging the engaging recesses 36, respectively. The thickness of the anodic alumina film is about 60˜200 μm (micron). The heat sink 39a includes a main body 390a and a plurality of heat dissipation fins 392a extending downwardly and perpendicularly from a bottom surface of the main body 390a. At a bottom surface, the anodic alumina film is provided with a plurality of engaging recesses 38, aligned with the protrusions 37 of the anodic alumina film. A plurality of protrusions 394 are provided at a top surface of the main body 390a of the heat sink 39a and are aligned with the engaging recesses 38 of the anodic alumina film. The protrusions 394 are received in the engaging recesses 38, thereby mounting the heat sink 39a to the anodic alumina film.

It is to be understood that even though numerous characteristics and advantages of the present invention have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode device comprising:
a base;
a plurality of light emitting diode chips mounted on a top surface of the base;
a plurality of encapsulation materials provided on the top surface of the base and encapsulating the light emitting diode chips therein; and
a heat dissipation substrate fixedly attached to a bottom surface of the base, the heat dissipation substrate being of a porous material and defining a plurality of pores therein, wherein the pores communicate with each other.

2. The light emitting diode device of claim 1, wherein the base defines a plurality of engaging recesses at the bottom surface thereof, the heat dissipation substrate forming a plurality of protrusions at a top surface thereof corresponding to the engaging recesses, and the protrusions of the heat dissipation substrate being received in the engaging recesses of the base, respectively.

3. The light emitting diode device of claim 2, wherein the base defines a plurality of receiving recesses at the top surface thereof, the light emitting diode chips being received in the receiving recesses, respectively.

4. The light emitting diode device of claim 3, wherein the receiving recesses are aligned with the engaging recesses along a vertical axis of the base, respectively.

5. The light emitting diode device of claim 1, wherein the base is of a metal, and the heat dissipation substrate is of a metallic foam material.

6. The light emitting diode device of claim 1, wherein the base is of a metal, and the heat dissipation substrate is of sintered metal powders.

7. The light emitting diode device of claim 1, wherein the base is aluminum, and the heat dissipation substrate is a porous anodic alumina film integrally formed with the base.

8. The light emitting diode device of claim 7, further comprising a heat sink fixedly attached to a bottom surface of the heat dissipation substrate.

9. The light emitting diode device of claim 1, wherein the heat dissipation substrate is provided with a plurality of engaging recesses at a bottom surface thereof, a heat sink is provided with a main body and a plurality of fins extending from the main body, and a plurality of protrusions are provided from the main body and engaged in the engaging recesses of the heat dissipation substrate, respectively.

10. A light emitting diode device comprising:
a base defining a plurality of engaging recesses at a bottom surface thereof;
a plurality of light emitting diode chips mounted on a top surface of the base; and
a heat dissipation substrate fixedly attached to the bottom surface of the base, the heat dissipation substrate forming a plurality of protrusions at a top surface thereof corresponding to the engaging recesses, the protrusions of the heat dissipation substrate being received in the engaging recesses of the base, respectively, the heat dissipation substrate being of a porous material and defining a plurality of pores therein, wherein the pores communicate with each other.

11. The light emitting diode device of claim 10, wherein the base is provided with a plurality of receiving recesses at the top surface thereof, the receiving recesses aligned with the engaging recesses along a vertical axis of the base, respectively, the light emitting diode chips being received in the receiving recesses of the top surface of the base.

12. The light emitting diode device of claim 11, wherein the base is of a metal, and the heat dissipation substrate is of a metallic foam material or sintered metal powders.

13. The light emitting diode device of claim 11, wherein the base is aluminum, and the heat dissipation substrate is a porous anodic alumina film integrally formed with the base.

14. The light emitting diode device of claim 10, wherein the heat dissipation substrate is provided with a plurality of engaging recesses at a bottom surface thereof, a heat sink is provided with a main body and a plurality of fins extending from the main body, and a plurality of protrusions are provided from the main body and engaged in the engaging recesses of the heat dissipation substrate, respectively.
